(19) United States
(12) Patent Application Publication
(10) Pub. No.: US 2026/0359160 A1
(43) Pub. Date: Nov. 12, 2026

(54) ABNORMAL GPU OPERATION IDENTIFICATION AND REMEDIATION SYSTEM

(71) Applicant: Dell Products L.P., Round Rock, TX (US)

(72) Inventors: Raveendra Reddy Padala, Bangalore (IN); Manjunath Alaghatta Marulappa, Bangalore (IN); Ajeesh Kumar, Bangalore (IN); Rama Rao Bisa, Bangalore (IN); Deepthi Shree Bhat, Bangalore (IN); Abhishek Ramachandra Manganawar, Bangalore (IN); Pavan Kumar Gavvala, Bangalore (IN)

(21) Appl. No.: 19/199,943

(22) Filed: May 6, 2025

(51) Int. Cl. G06F 11/07; G06F 1/26; G06T 1/20

(52) U.S. Cl. CPC G06F 11/0793; G06F 1/26; G06F 11/0721; G06T 1/20

(57) ABSTRACT

An abnormal GPU operation identification and remediation system includes an abnormal GPU operation identification and remediation device coupled to homogeneous GPU devices. The abnormal GPU operation identification and remediation device retrieves GPU telemetry data from a sensor system that is generated by each of the homogeneous GPU devices during their performance of equal portions of the processing operations required to provide the workload. If the abnormal GPU operation identification and remediation device determines that first GPU telemetry data generated by a first GPU device deviates from second GPU telemetry data generated by each of the other homogeneous GPU devices by more than a threshold, it performs a GPU device remediation action that prevents the first GPU device from generating the first GPU telemetry data that deviates from the second GPU telemetry data generated by each of the other homogeneous GPU devices by more than the threshold.

### BACKGROUND

The present disclosure relates generally to information handling systems, and more particularly to identifying and remediating abnormally operating GPU devices used by information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices and/or other computing devices known in the art, sometimes use Graphics Processing Unit (GPU) devices to perform workloads. In some situations, GPU devices performing workloads may operate abnormally and produce power consumption anomalies, temperature anomalies, memory usage anomalies, and/or other GPU device operating anomalies that would be apparent to one of skill in the art in possession of the present disclosure. As will be appreciated by one of skill in the art in possession of the present disclosure, such abnormal operation by a GPU device may indicate that the GPU device in an unhealthy state and, if not addressed, can lead to the unavailability of the GPU device, unavailability of other healthy GPU devices (e.g., when the unhealthy GPU devices consumes enough power such that power is not available to those healthy GPU devices), and/or other issues that can require time consuming GPU troubleshooting operations and/or GPU device replacement operations.

Accordingly, it would be desirable to provide abnormal GPU operation identification and remediation system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide an abnormal Graphics Processing Unit (GPU) operation identification and remediation engine that is configured to: retrieve, from a sensor system that is coupled to the processing system and a plurality of homogeneous GPU devices, GPU telemetry data generated by each of the plurality of homogeneous GPU devices during their performance of equal portions of processing operations required to provide a workload; determine that first GPU telemetry data generated by a first GPU device that is included in the plurality of homogeneous GPU devices deviates from second GPU telemetry data generated by each of a plurality of second GPU devices that are included in the plurality of homogeneous GPU devices by more than a GPU telemetry data threshold; and perform, in response to determining that the first GPU telemetry data deviates from the second GPU telemetry data by more than the GPU telemetry data threshold, a GPU device remediation action on the first GPU device that prevents the first GPU device from generating the first GPU telemetry data that deviates from second GPU telemetry data generated by each of the plurality of second GPU devices by more than the GPU telemetry data threshold.

### BRIEF DESCRIPTION OF THE DRAWINGS

FIG. 1 is a schematic view illustrating an embodiment of an Information Handling System (IHS).

FIG. 2 is a schematic view illustrating an embodiment of an abnormal GPU operation identification and remediation system that may be provided according to the teachings of the present disclosure.

FIG. 3 is a flow chart illustrating an embodiment of a method for identifying and remediating abnormal GPU device operation.

FIG. 4 is a schematic view illustrating an embodiment of the abnormal GPU operation identification and remediation system of FIG. 2 operating during the method of FIG. 3.

FIG. 5 is a schematic view illustrating an embodiment of the abnormal GPU operation identification and remediation system of FIG. 2 operating during the method of FIG. 3.

FIG. 6 is a schematic view illustrating an embodiment of the abnormal GPU operation identification and remediation system of FIG. 2 operating during the method of FIG. 3.

FIG. 7 is a schematic view illustrating an embodiment of the abnormal GPU operation identification and remediation system of FIG. 2 operating during the method of FIG. 3.

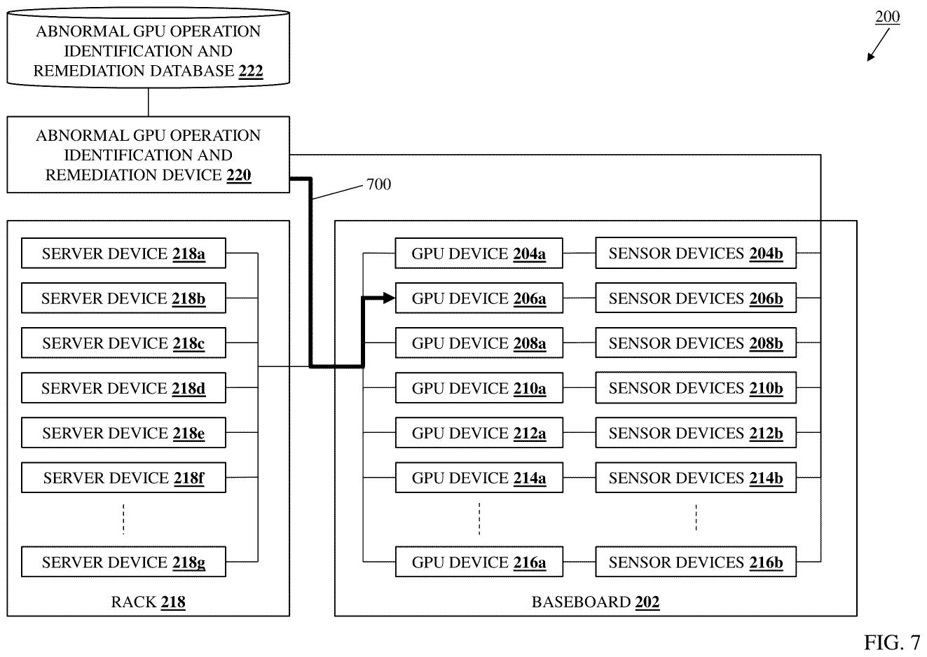

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

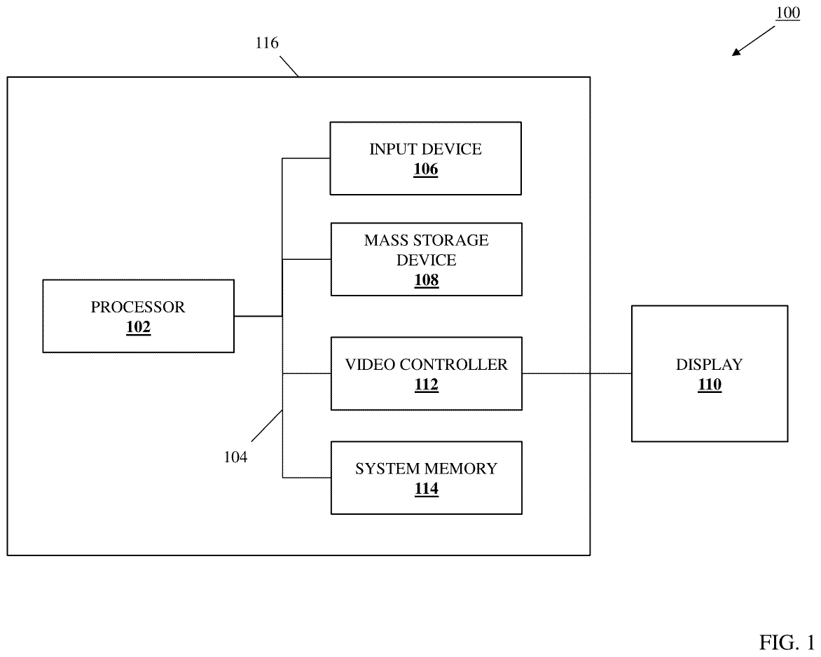

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

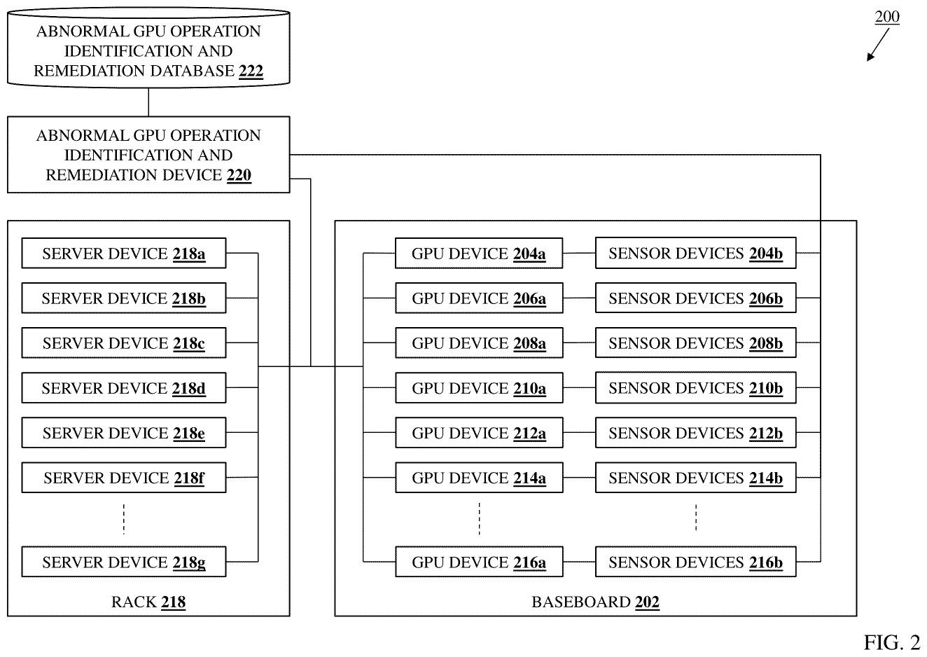

Referring now to FIG. 2, an embodiment of an abnormal GPU operation identification and remediation system 200 is illustrated that may be provided according to the teachings of the present disclosure. In the illustrated embodiment, the abnormal GPU operation identification and remediation system 200 includes a baseboard 202 that may be provided by a Universal Base Board (UBB) and/or other multi-GPU-device circuit boards that would be apparent to one of skill in the art in possession of the present disclosure. As illustrated, a plurality of GPU devices 204a, 206a, 208a, 210a, 212a, 214a, and up to 216a may be included, connected to, and/or otherwise coupled to the baseboard 202. However, while the plurality of GPU devices 204a-216a in the abnormal GPU operation identification and remediation system 200 are illustrated as being provided on a baseboard, one of skill in the art in possession of the present disclosure will appreciate how the GPU devices 204a-216a may be provided on a plurality of circuit boards while remaining within the scope of the present disclosure as well.

As discussed in further detail below, the plurality of GPU devices 204a-216a may be provided by homogeneous GPU devices that may each be the same GPU model (e.g., GPU devices with the same model number) of GPU device provided by the same GPU device provider/vendor (e.g., the “H100” GPU available from NVIDIA® corporation of Santa Clara, California, United States), and as described below may be expected to produce substantially similar telemetry data (e.g., health and Self-Monitoring, Analysis, and Reporting Technology (SMART) information such as power consumption telemetry data, temperature data, memory usage telemetry data, etc., that is within a predefined telemetry data range) when performing equal portions of processing operations (e.g., the same amount of the same type(s) of processing operations, processing operations that require a number of Floating Point Operations Per Second (FLOPS) with a predefined FLOPS range, equalized workload operation distribution and allocation for optimized parallel performance, and/or using other processing similarity measurements that would be apparent to one of skill in the art in possession of the present disclosure) for a workload while operating normally. However, while homogeneous GPU devices that are each the same GPU model of GPU device provided by the same GPU device provider are described, one of skill in the art in possession of the present disclosure will appreciate how in other embodiments homogeneous GPU devices may be provided by different GPU models of GPU devices provided by the same or different GPU providers as long as those GPU devices may be expected to produce the substantially similar telemetry data described herein when performing the substantially similar processing operations described herein while operating normally.

In an embodiment, a sensor system may be coupled to the GPU devices 204a-216a and, in the illustrated example, is provided by a plurality of sensor devices 204b, 206b, 208b, 210b, 212b, 214b, and up to 216b that are included on the baseboard 202 and coupled to each of the GPU devices 204a, 206a, 208a, 210a, 212a, 214a, and up to 216a, respectively. For example, the plurality of sensors devices coupled to each of the GPU devices 204a-216a may be provided by Reliability, Availability, and Serviceability (RAS) sensor devices that one of skill in the art in possession of the present disclosure will appreciate include specialized monitoring components that are configured to ensure relatively high uptime and operational efficiency by detecting and reporting telemetry data related to device health, device performance, and potential failures. To provide a specific example, the plurality of sensors devices coupled to each of the GPU devices 204a-216a may include temperature sensor devices for monitoring the temperature of the GPU device, power consumption sensor devices (e.g., voltage regulators) for monitoring power consumption of the GPU device, memory usage monitoring sensor devices (e.g., Error Correcting Code (ECC) memory usage monitoring sensor devices) for monitoring memory errors, cooling fan speed sensor devices for monitoring the use of cooling fans, network connectivity and bandwidth sensor devices for monitoring the use of a network, and/or any other sensor device that one of skill in the art in possession of the present disclosure would recognize as providing for the detection of abnormal GPU device operation as described below.

However, while a specific sensor system is illustrated and described in the examples below, one of skill in the art in possession of the present disclosure will appreciate how telemetry data generated by GPU devices during their performance of workloads may be monitored using a variety of sensor systems having a variety of configurations (e.g., a single set of sensor devices that monitor each of the plurality of GPU devices) that will fall within the scope of the present disclosure as well.

As illustrated in FIG. 2, the abnormal GPU operation identification and remediation system 200 may include a rack 218 that houses a plurality of server deices 218a, 218b, 218c, 218d, 218e, 218f, and up to 218g that are each coupled to the plurality of GPU devices 204a-216a such that any of the server devices 218a-218g may utilize any of the GPU devices 204a-216a to perform workloads as described below. In an embodiment, any or each of the server devices 218a-218g may be provided by the IHS 100 discussed above with reference to FIG. 1, and/or may include some or all of the components of the IHS 100. However, while illustrated and discussed as being utilized by server devices in a rack, one of skill in the art in possession of the present disclosure will recognize that the GPU devices 204a-216a provided in the abnormal GPU operation identification and remediation system 200 may be utilized by other types of computing devices that may be configured to operate similarly as the server devices 218a-218g discussed below while provided in any of a variety of configurations (e.g., outside of a rack).

The abnormal GPU operation identification and remediation system 200 also includes an abnormal GPU operation identification and remediation device 220 that is coupled to each of the GPU devices 204a-216a and each of the sensor devices 204b-216b. In an embodiment, the abnormal GPU operation identification and remediation device 220 may be provided by a Baseboard Management Controller (BMC) device such as the integrated DELL® Remote Access Controller (iDRAC) included in the server devices available from DELL® Inc. of Round Rock, Texas, United States, and/or other BMC devices that would be apparent to one of skill in the art in possession of the present disclosure. In the examples described below, the abnormal GPU operation identification and remediation device 220 is illustrated as being separate from the server devices 218a-218g, but one of skill in the art in possession of the present disclosure will appreciate how the abnormal GPU operation identification and remediation device 220 may be included in any of the server devices 218a-218g (e.g., as a BMC device in that server device) while remaining within the scope of the present disclosure as well.

As will be appreciated by one of skill in the art in possession of the present disclosure, the abnormal GPU operation identification and remediation device 220 may include a processing system (not illustrated, but which may be similar to the processor 102 discussed above with reference to FIG. 1) and a memory system (not illustrated, but which may be similar to the memory 114 discussed above with reference to FIG. 1) that is coupled to the processing system and that includes instructions that, when executed by the processing system, cause the processing system to provide an abnormal GPU operation identification and remediation engine that is configured to perform the functionality of the abnormal GPU operation identification and remediation engines and/or abnormal GPU operation identification and remediation devices discussed below.

The abnormal GPU operation identification and remediation system 200 may also include a storage system (not illustrated, but which may be similar to the storage 108 discussed above with reference to FIG. 1) that is coupled to the abnormal GPU operation identification and remediation engine (e.g., via a coupling between the storage system and the processing system) in the abnormal GPU operation identification and remediation device 220 and that includes an abnormal GPU operation identification and remediation database 222 that is configured to store any of the information utilized by the abnormal GPU operation identification and remediation engines and/or abnormal GPU operation identification and remediation devices discussed below. However, while a specific abnormal GPU operation identification and remediation system 200 has been illustrated and described, one of skill in the art in possession of the present disclosure will recognize that abnormal GPU operation identification and remediation systems (or other systems operating according to the teachings of the present disclosure in a manner similar to that described below for the abnormal GPU operation identification and remediation system 200) may include a variety of components and/or component configurations for providing conventional GPU system functionality, as well as the abnormal GPU operation identification and remediation functionality discussed below, while remaining within the scope of the present disclosure as well.

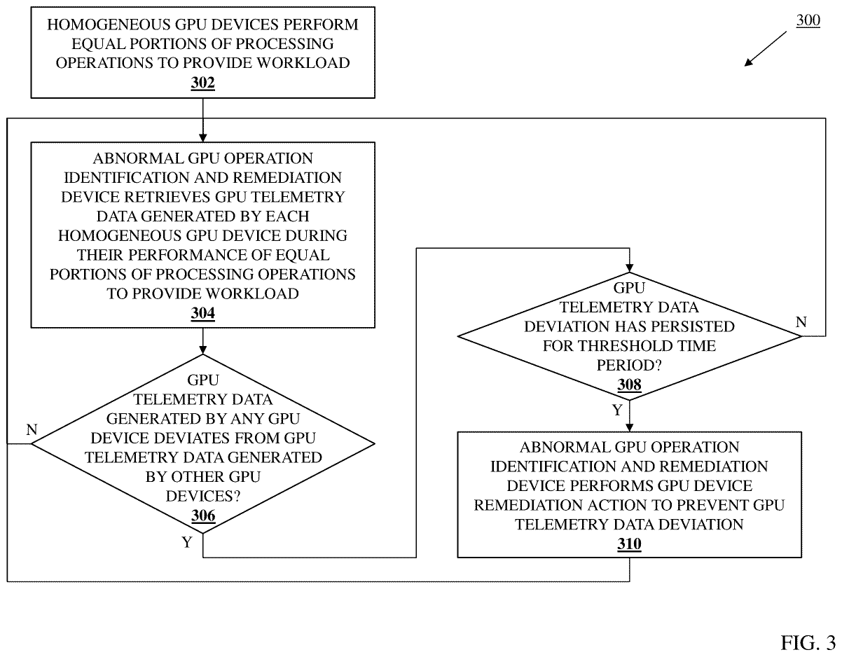

Referring now to FIG. 3, an embodiment of a method 300 for identifying and remediating abnormal Graphics Processing Unit (GPU) device operation is illustrated. As discussed below, the systems and methods of the present disclosure configure homogeneous GPU devices to each perform an equal portion of processing operations required to provide a workload, and then determine whether GPU telemetry data generated by any of those GPU devices deviates from GPU telemetry data generated by the other GPU devices. For example, the abnormal GPU operation identification and remediation system of the present disclosure may include an abnormal GPU operation identification and remediation device coupled to homogeneous GPU devices. The abnormal GPU operation identification and remediation device retrieves GPU telemetry data from a sensor system that is generated by each of the homogeneous GPU devices during their performance of equal portions of the processing operations required to provide the workload. If the abnormal GPU operation identification and remediation device determines that first GPU telemetry data generated by a first GPU device deviates from second GPU telemetry data generated by each of the other homogeneous GPU devices by more than a threshold, it performs a GPU device remediation action that prevents the first GPU device from generating the first GPU telemetry data that deviates from the second GPU telemetry data generated by each of the other homogeneous GPU devices by more than the threshold. As such, the abnormal operation of any of a plurality of homogenous GPU devices may be quickly and easily identified and remediated.

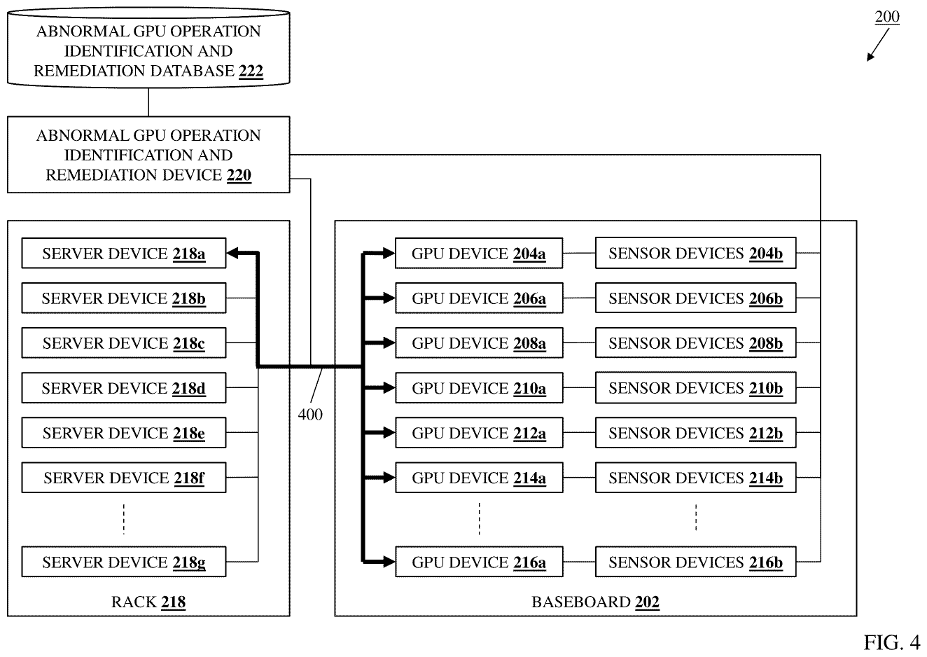

The method 300 begins at block 302 where homogeneous GPU devices perform equal portions of processing operations to provide a workload. With reference to FIG. 4, in an embodiment of block 302, the server device 218a and the GPU devices 204a-216a may perform workload performance operations 400 that include the server device 218a using the GPU devices 204a-216a to perform a workload using any of a variety of workload offload and GPU-enabled distributed workload performance techniques that would be apparent to one of skill in the art in possession of the present disclosure. As will be appreciated by one of skill in the art in possession of the present disclosure, while a particular server device 218a is illustrated and described as using all of the GPU devices 204a-216a to perform the workload in the examples below, any of the other server devices 218b-218g may utilize the GPU devices 204a-216a in a similar manner to perform a workload, as well as how subsets of the GPU devices 204a-216a (i.e., rather than all of the GPU devices 204a-216a and illustrated and described herein) may be used to perform workloads, while remaining within the scope of the present disclosure as well.

In some embodiments, during or prior to the method 300, the plurality of GPU devices may be configured to perform equal portions of the processing operations to provide the workload at block 302, with the “equal portions” of the processing operations that provide the workload defined in a manner that is expected to cause the plurality of GPU devices to produce substantially similar telemetry data (e.g., health and Self-Monitoring, Analysis, and Reporting Technology (SMART) information such as power consumption telemetry data, temperature data, memory usage telemetry data, etc., that is within a predefined telemetry data range) when performing those equal portions of processing operations (e.g., the same amount of the same type(s) of processing operations, processing operations that require a number of Floating Point Operations Per Second (FLOPS) with a predefined FLOPS range, equalized workload operation distribution and allocation for optimized parallel performance, and/or using other processing similarity measurements that would be apparent to one of skill in the art in possession of the present disclosure) for a workload while operating normally. However, while some specific examples are provided, one of skill in the art in possession of the present disclosure will appreciate how the “equal portions” of the processing operations that provide the workload may be defined in a variety of manners that are expected to cause the plurality of GPU devices to produce substantially similar telemetry data when performing those equal portions of processing operations for a workload while operating normally.

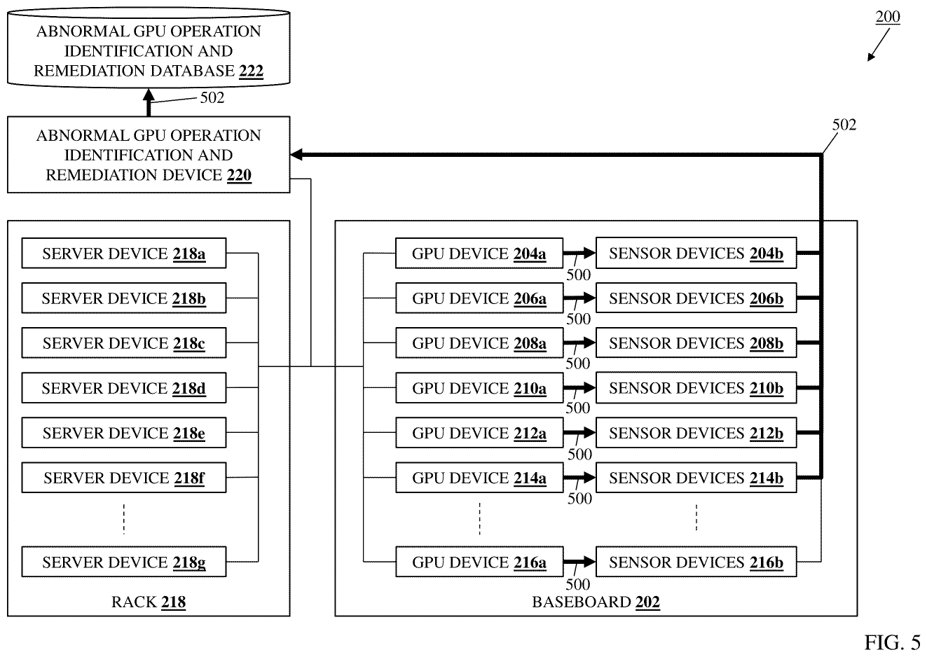

The method 300 then proceeds to block 304 where an abnormal GPU operation identification and remediation device retrieves GPU telemetry data generated by each homogeneous GPU device during their performance of the equal portions of the processing operations to provide the workload. With reference to FIG. 5, in an embodiment of block 304, each of the sensor devices 204b-216b may perform GPU telemetry data monitoring operations 500 that include monitoring their respective GPU devices 204a-216a and, in response, generating GPU telemetry data for each of those GPU devices 204a-216a based on that monitoring. In the examples below, the GPU telemetry data monitoring operations 500 include the sensor devices 204a-216b monitoring the power consumption and/or temperature of respective GPU devices 204a-216a and, in response, generating power consumption telemetry data and/or temperature telemetry data for those GPU devices 204a-216a based on that monitoring, but one of skill in the art in possession of the present disclosure will appreciate how other GPU telemetry data (e.g., memory usage telemetry data) may be generated for the GPU devices 204a-216a based on the monitoring of those GPU devices 204a-216a while remaining within the scope of the present disclosure.

With continued reference to FIG. 5, in an embodiment of block 304, the abnormal GPU operation identification and remediation device 220 may perform GPU telemetry data retrieval operations 502 that include retrieving the GPU telemetry data generated for the GPU devices 204a-216a by the sensor devices 204b-216b, respectively, and storing the GPU telemetry data in the abnormal GPU operation identification and remediation database 222. As discussed below, block 304 may be performed throughout the method 300 and across multiple iterations of the method 300 during different time periods, and one of skill in the art in possession of the present disclosure will appreciate how any particular performance of block 304 of the method 300 may result in the abnormal GPU operation identification and remediation device 220 retrieving and storing GPU telemetry data generated by the sensor devices 204b-216b, respectively, based on the operation of the GPU devices 204a-216a performing equal portions of the processing operations for the workload during a particular time period. As such, in a specific example of a first iteration of the method 300 that is referenced in further detail below, the abnormal GPU operation identification and remediation device 220 may retrieve and store GPU telemetry data generated by the sensor devices 204b-216b, respectively, based on the operation of the GPU devices 204a-216a performing equal portions of the processing operations for the workload during a first time period.

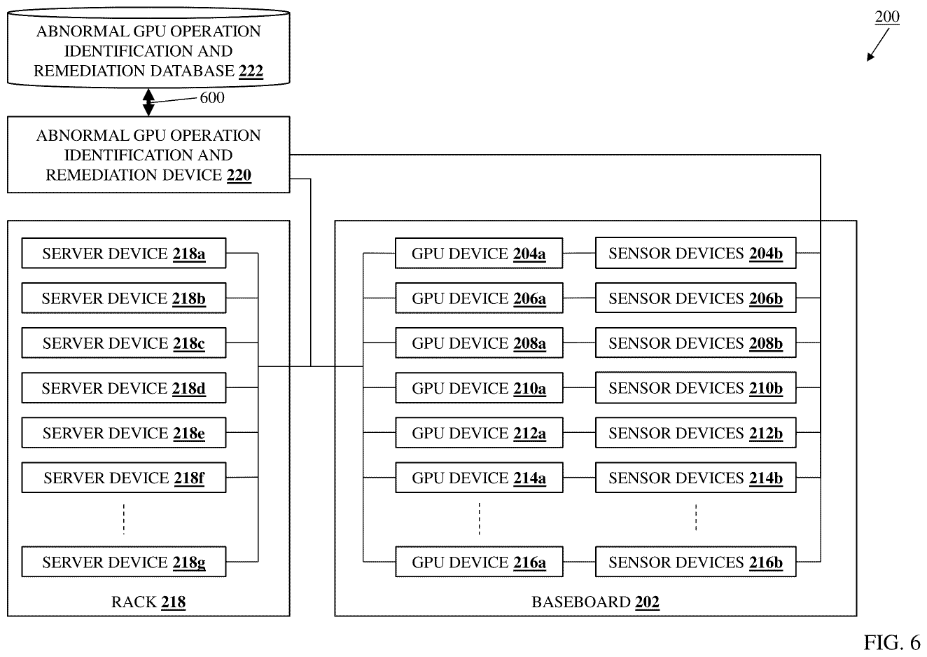

The method 300 then proceeds to decision block 306 where the method 300 proceeds depending on whether the GPU telemetry data generated by any of the GPU devices deviates from the GPU telemetry data generated by the other GPU devices. With reference to FIG. 6, in an embodiment of decision block 306, the abnormal GPU operation identification and remediation device 220 may perform GPU telemetry data deviation detection operations 600 that include comparing the GPU telemetry data retrieved at block 304 to determine whether the GPU telemetry data generated by any particular sensor devices for any particular GPU device deviates from the GPU telemetry data generated by the other sensor devices for the other GPU devices, and may involve the use of any of a variety of “spot the odd” algorithms that would be apparent to one of skill in the art in possession of the present disclosure. As such, continuing with the specific example of the first iteration of the method 300 above, a first performance of decision block 306 may include the abnormal GPU operation identification and remediation device 220 comparing the GPU telemetry data retrieved at a first iteration of block 304 to determine whether the GPU telemetry data generated by any particular sensor devices for any particular GPU device during the first time period deviates from the GPU telemetry data generated by the other sensor devices for the other GPU devices during the first time period.

In an embodiment, deviation of first GPU telemetry data generated by first sensor devices for a first GPU device from second GPU telemetry data generated by the second sensor devices for second GPU devices may be identified by the abnormal GPU operation identification and remediation device 220 when the first GPU telemetry data differs from the second GPU telemetry data by more than a GPU telemetry data deviation threshold (which may be stored in the abnormal GPU operation identification and remediation database 222). To provide a specific example, the GPU telemetry data deviation threshold may be 5% (e.g., first power consumption telemetry data will be identified as deviating from second power consumption telemetry data if the first power consumption telemetry data is more than 5% greater or less than the second power consumption telemetry data, first temperature telemetry data will be identified as deviating from second temperature telemetry data if the first temperature telemetry data is more than 5% greater or less than the second temperature telemetry data, etc.). However, while a specific GPU telemetry data deviation threshold has been described, one of skill in the art in possession of the present disclosure will appreciate that the GPU telemetry data deviation threshold may differ for different GPU telemetry data, may be greater than or less than 5%, and/or may otherwise be based on a variety of abnormal GPU device operation considerations that would be apparent to one of skill in the art in possession of the present disclosure.

In some embodiments in which all of the GPU devices 204a-216a are going used to perform the workload, the determination of whether GPU telemetry data generated by first sensor devices for a first GPU device during a time period deviates from second GPU telemetry data generated by the second sensor devices for second GPU devices during that time period may include comparing the first GPU telemetry data generated for the first GPU device to the GPU telemetry data generated for each of all of the other GPU devices (e.g., comparing the GPU telemetry data generated for the GPU device 206a to the GPU telemetry data generated for each of all of the other GPU devices 204a, 208a, 210a, 212a, 214a, and up to 216a). As will be appreciated by one of skill in the art in possession of the present disclosure, such embodiments may be used to detect when only one of the GPU devices 204a-216a is operating abnormally.

However, in other embodiments in which all of the GPU devices 204a-216a are going used to perform the workload, the determination of whether GPU telemetry data generated by first sensor devices for a first GPU device during a time period deviates from second GPU telemetry data generated by the second sensor devices for second GPU devices during that time period may include comparing the first GPU telemetry data generated for the first GPU device to the GPU telemetry data generated for each of a subset of the other GPU devices that is less than all of the other GPU devices (e.g., comparing the GPU telemetry data generated for the GPU device 206a to the GPU telemetry data generated for the other GPU devices 204a, 208a, 212a, and up to 214a). As will be appreciated by one of skill in the art in possession of the present disclosure, such embodiments may be used to detect when more than one of the GPU devices 204a-216a are operating abnormally.

To provide a specific example, one of skill in the art in possession of the present disclosure will appreciate how the method 300 may be performed to determine that the GPU telemetry data generated for the GPU devices 204a, 208a, 212a, and up to 214a is all within the GPU telemetry data deviation threshold while the GPU telemetry data generated for the GPU devices 206a and 210a is not, and then may perform the GPU telemetry data deviation detection operations 600 for 1) the GPU device 206a relative to the GPU devices 204a, 208a, 212a, and up to 214a, and may perform the GPU telemetry data deviation detection operations 600 for 2) the GPU device 210a relative to the GPU devices 204a, 208a, 212a, and up to 214a. In other words, if a majority of the GPU devices (“second GPU devices”) are each generating second GPU telemetry data that is within the GPU telemetry data deviation threshold of each other while more than one of the GPU devices (“first GPU devices) are generating first GPU telemetry data that deviates from the second GPU telemetry data by the GPU telemetry data deviation threshold, the blocks of the method 300 below may be performed separately for each of those first GPU devices.

If, at decision block 306, no GPU telemetry data generated by any of the GPU devices deviates from the GPU telemetry data generated by the other GPU devices, the method 300 returns to block 304. In an embodiment, at decision block 306, the GPU telemetry data deviation detection operations 600 performed by the abnormal GPU operation identification and remediation device 220 may determine that no the GPU telemetry data generated by any of the sensor devices 204b-216b for the GPU devices 204a-216a deviates from the GPU telemetry data generated by the other sensor devices 204b-216b for the other GPU devices 204a-216a, respectively, which one of skill in the art in possession of the present disclosure will appreciate indicates normal/healthy operation of each of the homogeneous GPU devices 204a-216a that are expected to generate similar GPU telemetry data (e.g., GPU telemetry data within the GPU telemetry data deviation threshold discussed above) when configured to each perform an equal portion of the processing operations to provide the workload. As such, the method 300 may loop through block 304 and decision block 306 such that the abnormal GPU operation identification and remediation device 220 continues to retrieve GPU telemetry data generated for the GPU devices 204a-216a and determine whether any of that GPU telemetry data deviates from the other GPU telemetry data as long as none of that GPU telemetry data deviates from the other GPU telemetry data.

If, at decision block 306, GPU telemetry data generated by any of the GPU devices deviates from the GPU telemetry data generated by the other GPU devices, the method 300 proceeds to decision block 308 where the method 300 proceeds depending on whether the GPU telemetry data deviation has persisted for a threshold time period. In the specific embodiment described below, the abnormal GPU operation identification and remediation device 220 determines that GPU telemetry data generated for the GPU device 206a deviates from GPU telemetry data generated for the other GPU devices 204a and 208a-216a (e.g. power consumption of the GPU device 206a indicated by its power consumption telemetry data is over 5% greater than power consumption of each of the GPU devices 208a-216a indicated by their power consumption telemetry data, a temperature of the GPU device 206a indicated by its temperature telemetry data is over 5% greater than the temperatures of each of the GPU devices 208a-216a indicated by their temperature telemetry data, etc.), which one of skill in the art in possession of the present disclosure will appreciate may indicate abnormal/unhealthy operation of the GPU device 206a and could eventually lead to an unavailability of the GPU device 206a (or an unavailability of one or more of the GPU devices 204a and 208a-216a if, for example, the GPU device 206a consumes power in an amount that “starves” those other GPU devices 204a and 208a-216a).

In an embodiment, in response to determining that GPU telemetry data generated for the GPU device 206a deviates from GPU telemetry data generated for the other GPU devices 204a and 208a-216a, the abnormal GPU operation identification and remediation device 220 may log that GPU telemetry data deviation (e.g., in a lifecycle log stored in the abnormal GPU operation identification and remediation database 222). Furthermore, while the specific example provided herein describes the GPU device 206a producing GPU telemetry data that deviates from the GPU telemetry data generated for the GPU devices 204a and 208a-216a, one of skill in the art in possession of the present disclosure will appreciate how any of the GPU devices 206a-216a may generate GPU telemetry data that deviates from the GPU telemetry data generated for the other GPU devices 206a-216a as a result of abnormal operations while remaining within the scope of the present disclosure as well.

In an specific embodiment, at decision block 308 and in response to determining that GPU telemetry data generated for the GPU device 206a deviates from GPU telemetry data generated for the other GPU devices 204a and 208a-216a at decision block 306, the abnormal GPU operation identification and remediation device 220 may perform GPU telemetry data deviation persistence determination operations that include determining whether that GPU telemetry data generated for the GPU device 206a has deviated from GPU telemetry data generated from the other GPU devices 204a and 208a-216a for more than a GPU telemetry data deviation threshold time period.

To provide a specific example, the GPU telemetry data deviation threshold time period may be defined as a time period measured by five performances of blocks 304 and 306 during consecutive iterations of the method 300 that are performed within a threshold time period. As such, following a first iteration of the method 300 in which a first GPU device is identified as producing GPU telemetry data that deviates from GPU telemetry data generated for second GPU devices during a first performance of blocks 304 and 306, that first GPU device must be identified as producing GPU telemetry data that that deviates from GPU telemetry data generated for second GPU devices in four more performances of blocks 304 and 306 in consecutive iterations of the method 300 that occur during a threshold time period. However, while a specific example has been provided, one of skill in the art in possession of the present disclosure will appreciate how persistent deviation of GPU telemetry data generated for a first GPU device from GPU telemetry data generated for other GPU devices may be defined in a variety of manners that will fall within the scope of the present disclosure as well.

If, at decision block 308, the GPU telemetry data deviation has not persisted for the threshold time period, the method 300 returns to block 304. As such, the method 300 may loop until either the deviation of GPU telemetry data generated for any of the GPU devices 204a-216a relative to GPU telemetry data generated for the other GPU devices 204a-216a persists for the GPU telemetry data deviation threshold time period, or the deviation of GPU telemetry data generated for any of the GPU devices 204a-216a relative to GPU telemetry data generated for the other GPU devices 204a-216a does not persist for the GPU telemetry data deviation threshold time period and the method 300 begins to loop through blocks 304 and 306 as described above.

If, at decision block 308, the GPU telemetry data deviation has persisted for the threshold time period, the method 300 proceeds to block 310 where the abnormal GPU operation identification and remediation device performs a GPU device remediation action to prevent the GPU telemetry data deviation. Continuing with the specific example provided above, following a first iteration of the method 300 in which the GPU telemetry data generated for the GPU device 206a is identified as deviating relative to GPU telemetry data generated for the GPU devices 204a and 208a-216a, the method 300 may loop through four subsequent consecutive iterations of the method 300 in which that deviation continues to be identified at respective performances of blocks 304, 306, and 308, and that deviation will be determined to have persisted for the GPU telemetry data deviation threshold time period at decision block 308.

In an embodiment, at block 310 and in response to determining that the GPU telemetry data generated for the GPU device 206a has persistently deviated from the GPU telemetry data generated for the GPU devices 204a and 208a-216a at decision block 308, the abnormal GPU operation identification and remediation device 220 may perform GPU device remediation operations 700 that include performing a GPU device remediation action on the GPU device 206a. In an embodiment, the GPU device remediation action performed by the abnormal GPU operation identification and remediation device 220 on the GPU device 206a may include power cycling the GPU device 206a by, for example, resetting the GPU device 206a by powering off the GPU device 206 followed by powering on the GPU device 206a, which one of skill in the art in possession of the present disclosure will appreciate may operate to cause the GPU device 206a to operate normally (e.g., by generating GPU telemetry data during a subsequent iteration of the method 300 that does not deviate from the GPU telemetry data generated by the GPU devices 204a and 208a-216a) after operating abnormally as described above. In an embodiment and in response to power cycling the GPU device 206a as described above, the abnormal GPU operation identification and remediation device 220 may log that the GPU device 206a was power cycled in a lifecycle log that may be stored in the abnormal GPU operation identification and remediation database 222.

In another embodiment, the GPU device remediation action performed by the abnormal GPU operation identification and remediation device 220 on the GPU device 206a may include powering down the GPU device 206a by, for example, powering off the GPU device 206, which one of skill in the art in possession of the present disclosure will appreciate may operate to prevent subsequent use of the GPU device 206a to perform the workload, and thus prevent the GPU device 206a from subsequently generating GPU telemetry data during a subsequent iteration of the method 300 that deviates from the GPU telemetry data generated for the GPU devices 204a and 208a-216a. However, while two specific GPU device remediation actions have been described, one of skill in the art in possession of the present disclosure will appreciate how other GPU device remediation actions may be performed to prevent the GPU device 206a from subsequently generating GPU telemetry data during a subsequent iteration of the method 300 that deviates from the GPU telemetry data generated for the GPU devices 204a and 208a-216a while remaining within the scope of the present disclosure as well. In an embodiment and in response to powering down the GPU device 206a as described above, the abnormal GPU operation identification and remediation device 220 may log that the GPU device 206a was powered down in a lifecycle log that may be stored in the abnormal GPU operation identification and remediation database 222.

Following block 310, the method 300 returns to block 304. To provide a specific example of the performance of block 310 of the method 300, a first performance of block 310 may include power cycling the GPU device 206a, with a subsequent iteration of the method 300 determining whether the GPU device 206a continues to generate GPU telemetry data that deviates from GPU data generated for the GPU devices 204a and 208a-216a. As will be appreciated by one of skill in the art in possession of the present disclosure, in the event the power cycling of the GPU device 206a at block 310 corrects the GPU telemetry data deviation of the GPU device 206a (e.g., the GPU device 206a generates GPU telemetry data during the subsequent iteration of the method 300 that does not deviate from the GPU telemetry data generated for the GPU devices 204a and 208a-216a), the method 300 may continue as described above. However, in the event the power cycling of the GPU device 206a at block 310 does not correct the GPU telemetry data deviation of the GPU device 206a (e.g., the GPU device 206a continues to generate GPU telemetry data during the subsequent iteration of the method 300 that deviates from the GPU telemetry data generated for the GPU devices 204a and 208a-216a), the subsequent performance of block 310 may include powering down the GPU device 206a as described above. Furthermore, the method 300 may provide for early GPU device operation issue detection by network administrators or other users by notifying them of abnormal operation of the GPU devices detected via the method 300 using the lifecycle logs, emails, texts, and/or other notification techniques that would be apparent to one of skill in the art in possession of the present disclosure.

Thus, systems and methods have been described that configure homogeneous GPU devices to each perform an equal portion of processing operations required to provide a workload, and then determine whether GPU telemetry data generated by any of those GPU devices deviates from GPU telemetry data generated by the other GPU devices. For example, the abnormal GPU operation identification and remediation system of the present disclosure may include an abnormal GPU operation identification and remediation device coupled to homogeneous GPU devices. The abnormal GPU operation identification and remediation device retrieves GPU telemetry data from a sensor system that is generated by each of the homogeneous GPU devices during their performance of equal portions of the processing operations required to provide the workload. If the abnormal GPU operation identification and remediation device determines that first GPU telemetry data generated by a first GPU device deviates from second GPU telemetry data generated by each of the other homogeneous GPU devices by more than a threshold, it performs a GPU device remediation action that prevents the first GPU device from generating the first GPU telemetry data that deviates from the second GPU telemetry data generated by each of the other homogeneous GPU devices by more than the threshold. As such, the abnormal operation of any of a plurality of homogenous GPU devices may be quickly and easily identified and remediated, and network administrators or other users of the GPU devices may be notified of any abnormal operation of those GPU devices so that they may attempt to address the issue causing the abnormal operation to prevent downtime of the GPU devices.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. An abnormal Graphics Processing Unit (GPU) operation identification and remediation system, comprising:
a plurality of homogeneous Graphics Processing Unit (GPU) devices that are configured to each perform an equal portion of processing operations required to provide a workload; and
an abnormal GPU operation identification and remediation device that is coupled to the plurality of homogeneous GPU devices and that is configured to:
retrieve, from a sensor system that is coupled to the plurality of homogeneous GPU devices, GPU telemetry data generated by each of the plurality of homogeneous GPU devices during their performance of the equal portions of the processing operations required to provide the workload;
determine that first GPU telemetry data generated by a first GPU device that is included in the plurality of homogeneous GPU devices deviates from second GPU telemetry data generated by each of a plurality of second GPU devices that are included in the plurality of homogeneous GPU devices by more than a GPU telemetry data threshold; and
perform, in response to determining that the first GPU telemetry data deviates from the second GPU telemetry data by more than the GPU telemetry data threshold, a GPU device remediation action on the first GPU device that prevents the first GPU device from generating the first GPU telemetry data that deviates from second GPU telemetry data generated by each of the plurality of second GPU devices by more than the GPU telemetry data threshold.

2. The system of claim 1, wherein the abnormal GPU operation identification and remediation device is a Baseboard Management Controller (BMC) device that is included in a server device that is using the plurality of homogeneous GPU devices to perform the workload.

3. The system of claim 1, wherein the GPU telemetry data is provided by at least one of power consumption telemetry data or temperature data.

4. The system of claim 1, wherein the determining that the first GPU telemetry data deviates from the second GPU telemetry data by more than the GPU telemetry data deviation threshold includes:
retrieving, from the sensor system during a plurality of different time periods, respective GPU telemetry data generated by each of the plurality of homogeneous GPU devices during their performance of the equal portions of the processing operations required to provide the workload; and
determining that the respective first GPU telemetry data generated by the first GPU device during each of the plurality of different time periods deviates from the respective second GPU telemetry data generated by each of the plurality of second GPU devices during each of the plurality of different time periods deviates by more than the GPU telemetry data threshold.

5. The system of claim 1, wherein the GPU device remediation action includes power cycling the first GPU device.

6. The system of claim 1, wherein the GPU device remediation action includes powering down the first GPU device.

7. An Information Handling System (IHS), comprising:
a processing system; and
a memory system that is coupled to the processing system and that includes instructions that, when executed by the processing system, cause the processing system to provide an abnormal Graphics Processing Unit (GPU) operation identification and remediation engine that is configured to:
retrieve, from a sensor system that is coupled to the processing system and a plurality of homogeneous GPU devices, GPU telemetry data generated by each of the plurality of homogeneous GPU devices during their performance of equal portions of processing operations required to provide a workload;
determine that first GPU telemetry data generated by a first GPU device that is included in the plurality of homogeneous GPU devices deviates from second GPU telemetry data generated by each of a plurality of second GPU devices that are included in the plurality of homogeneous GPU devices by more than a GPU telemetry data threshold; and
perform, in response to determining that the first GPU telemetry data deviates from the second GPU telemetry data by more than the GPU telemetry data threshold, a GPU device remediation action on the first GPU device that prevents the first GPU device from generating the first GPU telemetry data that deviates from second GPU telemetry data generated by each of the plurality of second GPU devices by more than the GPU telemetry data threshold.

8. The IHS of claim 7, wherein the processing system and the memory system are provided in a Baseboard Management Controller (BMC) device.

9. The IHS of claim 8, wherein the BMC device is included in a server device that is using the plurality of homogeneous GPU devices to perform the workload.

10. The IHS of claim 7, wherein the GPU telemetry data is provided by at least one of power consumption telemetry data or temperature data.

11. The IHS of claim 7, wherein the determining that the first GPU telemetry data deviates from the second GPU telemetry data by more than the GPU telemetry data deviation threshold includes:
retrieving, from the sensor system during a plurality of different time periods, respective GPU telemetry data generated by each of the plurality of homogeneous GPU devices during their performance of the equal portions of the processing operations required to provide the workload; and
determining that the respective first GPU telemetry data generated by the first GPU device during each of the plurality of different time periods deviates from the respective second GPU telemetry data generated by each of the plurality of second GPU devices during each of the plurality of different time periods deviates by more than the GPU telemetry data threshold.

12. The IHS of claim 7, wherein the GPU device remediation action includes power cycling the first GPU device.

13. The IHS of claim 7, wherein the GPU device remediation action includes powering down the first GPU device.

14. A method for identifying and remediating abnormal Graphics Processing Unit (GPU) device operation, comprising:
retrieving, by an abnormal Graphics Processing Unit (GPU) operation identification and remediation device from a sensor system, GPU telemetry data generated by each of the plurality of homogeneous GPU devices during their performance of equal portions of processing operations required to provide a workload;
determining, by the abnormal GPU operation identification and remediation device, that first GPU telemetry data generated by a first GPU device that is included in the plurality of homogeneous GPU devices deviates from second GPU telemetry data generated by each of a plurality of second GPU devices that are included in the plurality of homogeneous GPU devices by more than a GPU telemetry data threshold; and
performing, by the abnormal GPU operation identification and remediation device in response to determining that the first GPU telemetry data deviates from the second GPU telemetry data by more than the GPU telemetry data threshold, a GPU device remediation action on the first GPU device that prevents the first GPU device from generating the first GPU telemetry data that deviates from second GPU telemetry data generated by each of the plurality of second GPU devices by more than the GPU telemetry data threshold.

15. The method of claim 14, wherein the abnormal GPU operation identification and remediation device is provided by a Baseboard Management Controller (BMC) device.

16. The method of claim 15, wherein the BMC device is included in a server device that is using the plurality of homogeneous GPU devices to perform the workload.

17. The method of claim 14, wherein the GPU telemetry data is provided by at least one of power consumption telemetry data or temperature data.

18. The method of claim 14, wherein the determining that the first GPU telemetry data deviates from the second GPU telemetry data by more than the GPU telemetry data deviation threshold includes:
retrieving, by the abnormal GPU operation identification and remediation device from the sensor system during a plurality of different time periods, respective GPU telemetry data generated by each of the plurality of homogeneous GPU devices during their performance of the equal portions of the processing operations required to provide the workload; and
determining, by the abnormal GPU operation identification and remediation device, that the respective first GPU telemetry data generated by the first GPU device during each of the plurality of different time periods deviates from the respective second GPU telemetry data generated by each of the plurality of second GPU devices during each of the plurality of different time periods deviates by more than the GPU telemetry data threshold.

19. The method of claim 14, wherein the GPU device remediation action includes power cycling the first GPU device.

20. The method of claim 14, wherein the GPU device remediation action includes powering down the first GPU device.
